(19) United States
(12) Patent Application Publication
(10) Pub. No.: US 2020/0095776 A1
(43) Pub. Date: Mar. 26, 2020

(54) Adhesive Wall Finish Using Compressed Plastic Panel And Method For Manufacturing The Same

(71) Applicant: Yoon Hwan Kim, Gyeonggi-do (KR)

(72) Inventor: Yoon Hwan Kim, Gyeonggi-do (KR)

(21) Appl. No.: 16/141,387

(22) Filed: Sep. 25, 2018

(51) Int. Cl. E04F 13/08; B32B 5/18; B32B 7/12; B32B 27/06; B32B 27/08; B32B 27/32; B32B 27/30; B32B 7/06; B32B 38/00; E04F 13/18; E04C 2/26

(52) U.S. Cl. CPC E04F 13/0885; B32B 2451/00; B32B 7/12; B32B 27/065; B32B 27/08; B32B 27/32; B32B 27/304; B32B 7/06; B32B 38/0004; E04F 13/18; E04F 13/0866; E04C 2/26; B32B 2307/732; B32B 2307/54; B32B 2307/546; B32B 2307/558; B32B 2307/536; B32B 2250/04; B32B 2607/00; B32B 5/18

(57) ABSTRACT

The method of manufacturing an adhesive wall finish includes forming a compressed plastic panel having first and second sides, laminating a deco sheet onto the first side using an adhesive member, wherein the deco sheet is laminated with at least one decorative pattern, obtaining a PE foam sheet having a first side and a second side, forming a first adhesive face on the PE foam sheet by applying an adhesive member to the first side of the PE foam sheet and attaching a release paper thereto, forming a second adhesive face on the PE foam sheet by applying an adhesive member to the second side of the PE foam sheet and attaching a release paper thereto, laminating the second side of the compressed plastic panel with one side of the PE foam sheet through the first adhesive face, and cutting the compressed plastic panel to certain size specifications.

### FIELD OF THE INVENTION

The present invention relates to an adhesive wall finish using compressed plastic panel and a method for manufacturing the same. More specifically, the present invention relates to an adhesive wall finish using compressed plastic panel which can be easily used as a wall finish by a consumer, is hard and therefore not easily damaged by sharp objects, is highly moisture resistant while being flexible and less prone to cracking to maintain machinability while having high strength, is environmentally friendly due to use of environmentally friendly plasticizer, is able to achieve various wall finish colors and patterns, is convenient to install by being attachable over protrusions on a wall surface and being detachable and re-attachable multiple times even if improperly attached by a consumer, and which can be produced with various thickness and width specifications for greatly improved machinability and product diversity, and a method for manufacturing the same.

### BACKGROUND OF THE INVENTION

Normally, materials that consumers can use to finish a wall surface and create an interior decoration effect are limited to paints and wallpapers. Other finish materials are either too expensive or too difficult to install, making it difficult for consumers to apply them to a wall surface.

Further, these paints and wallpapers are limited in colors or pattern, and are also limited in giving a variety of effects or a sense of depth.

To solve such problems, Korean Patent No. 10-0643188 proposed “A method for producing a synthetic resin sheet wherein deco film is coated onto a thin, synthetic resin plate using an apparatus for manufacturing a synthetic resin sheet, the apparatus comprising: an extruder equipped with a plurality of heaters on its outer surface to extrude molten synthetic resin from an end opposite a first end through which it is fed synthetic resin pellets; a T-die that is connected to the opposite end of the extruder and has horizontal slits formed along a longitudinal direction, into which molten synthetic resin from the extruder is fed and where the synthetic resin is continuously extruded through the slits; a first roller and a second roller that roll the molten synthetic resin extruded continuously from the T-die into sheets with a desired thickness; a third roller that is provided above the second roller which is the higher positioned of the first roller and the second roller and which rotates by meshing with the second roller, where synthetic resin having passed between the first roller and second roller is passed between the third roller and the second roller under pressure, and; a deco film feed unit that continually feeds deco film, and characterized in that the deco film that is continually fed from the deco film feed unit passes through the first roller and the second roller together with the synthetic resin that is continually extruded from the T-die and becomes bonded to the upper face of the synthetic resin, and; that the first roller is maintained at 50 to 60° C., the second roller is maintained at 40 to 50° C., and the third roller is maintained at 80 to 100° C., where the method is characterized in that it comprises: a step of melting synthetic resin where synthetic resin in pellet form is inserted into an extruder equipped with a plurality of heaters on its outer surface; a step of extruding molten synthetic resin by continually extruding the molten synthetic resin through a T-die that is connected to the extruder and which is equipped with long horizontal slits; a step of rolling and bonding wherein the molten synthetic resin being continually extruded from the T-die and the continually fed deco film are passed together between the first roller maintained at 50 to 60° C. and the second roller maintained at 40 to 50° C. to roll the molten synthetic resin into a sheet of the desired thickness while simultaneously causing the deco film to bond to the synthetic resin, and; a smoothing step wherein the synthetic resin to which the deco film has been bonded and which has passed through the rolling and bonding step is passed through a third roller that rotates by meshing with the second roller and is maintained at 80 to 100° C. to increase the smoothness of the synthetic resin to which the deco film has been bonded.”

However, this art relates to a thin, hard synthetic resin seat onto which deco film has been bonded, which requires a separate process of attaching the same to another wall finish and cutting. Therefore, it cannot be used firsthand by a consumer as a wall finish.

Further, Korean Patent No. 10-1561674 proposes “A method for manufacturing interior finishing materials, the method comprising: (A) a step of preparing raw materials including cross-linked foam fabric, a shape-retaining film with hard properties, and a performance-enhancing film assembly to which metal has been vacuum deposited; (B) a step of laminating and bonding the cross-linked foam fabric and the shape-retaining film by melting the shape-retaining film onto the upper surface of the cross-linked foam fabric; (C) a step of compression molding a semi-finished product that is the result of step (B); (D) a step of laminating and bonding the semi-finished product that has been compression molded in step (C) with the performance-enhancing film assembly, and; (E) a step of cutting the result of step (D) to appropriate specifications to produce a wallpaper panel or cushion tile, characterized in that: in step (C), the semi-finished product is passed through a heating chamber having infra-red heaters for pre-heating for 45±5 seconds with an upper heater at a temperature of 100±10° C. and a bottom heater at a temperature of 120±10° C. and then pressed for 15±5 seconds under 80±5 kgf/cm2 pressure conditions using a forming roller to form embossed or engraved 3-dimensional patterns or shapes on the surface of the semi-finished product; that the cross-linked foam fabric is chemically cross-linked polyethylene foam; the shape-retaining film comprises one of PVC film, LDPE film, LLDPE film, CPE film, nylon film, and polyester film, with a pattern printed on the upper face thereof, and; that the performance-enhancing film assembly comprises a PET film, a vacuum-deposited metal layer comprising silver or aluminum which is formed on the upper face of the PET film through dry vacuum deposition, an adhesive layer that is formed on the bottom face of the PET film by applying adhesive or by attaching adhesive tape, and a release paper that covers the adhesive layer.” However, this relates to a wall paper panel or cushion type interior finish material common referred to as a “foam block”. Whereas these can be installed firsthand by general consumers as a wall finish, they are manufactured using molds for press-forming, severely limiting the size, shape and patterning of the product. Further, being a foam, they are vulnerable to heat and are easily damaged by sharp objects.

Further, when manufacturing these synthetic resin sheets, phthalate plasticizers, which improve the flexibility and elasticity of synthetic resin but have been identified as endocrine disruptors that cause liver and kidney disorder as well as genital deformity, whose use is restricted in wall finishes and in children's toys in Korea, and whose use is prohibited in advanced economies, are used, leading to another problem of environmental hormones.

### SUMMARY OF THE INVENTION

The purpose of the present invention, devised to solve the above-described problems, is to provide an adhesive wall finish using compressed plastic panel which: can be easily used as a wall finish firsthand by a consumer; is hard and therefore not easily damaged by sharp objects; is highly moisture resistant while being flexible and less prone to cracking to maintain machinability while having high strength; is environmentally friendly due to use of environmentally friendly plasticizer; is able to achieve various wall finish colors and patterns; is convenient to install by being attachable over protrusions on a wall surface and being detachable and re-attachable multiple times even if improperly attached by a consumer, and; which can be produced with various thickness and width specifications for greatly improved machinability and product diversity, and a method for manufacturing the same.

The present invention, to achieve the above-stated purpose, includes:

A step of using an environmentally friendly plasticizer that does not contain lead and does not contain or use phthalate plasticizer as an ingredient to produce a compressed plastic panel which is about 1 to 3 mm in thickness and is a rigid vinyl chloride foam panel;

A step of selectively using one of PET, PP and PVC, which are environmentally friendly synthetic resins, to obtain environmentally friendly deco sheet laminated with various patterns;

A step of laminating the environmentally friendly deco sheet on one side of the compressed plastic panel using an adhesive member;

A step of obtaining a PE foam sheet having a thickness of about 1 to 3 mm;

A step of forming an adhesive face of the PE foam sheet wherein an adhesive member is applied on one side of the PE foam sheet and the adhesive face is finished by attaching release paper thereto;

A step of forming an adhesive face of the PE foam sheet wherein an adhesive member is applied on the other side of the PE foam sheet and the adhesive face is finished by attaching release paper thereto;

A step of laminating one side of the PE foam sheet by affixing an adhesive face from which the release paper has been removed the other side of the compressed plastic panel having the deco sheet laminated onto one side thereof, and;

A step of cutting the compressed plastic panel laminated on one side with deco sheet and laminated with PE foam sheet on the other to certain size specifications.

[owls] The step of producing the compressed plastic panel, which is a rigid vinyl chloride foam panel, includes feeding the ingredients into a hopper of an extruder, then passing through a barrel heated to 150 to 195° C. any one of a manifold-type flat die, T-die and coat hanger type die, and then passing through a cooling water bath or two or more cooling rollers to continually produce vinyl chloride foam panels having: evenly distributed closed cells; a smooth surface; a foaming rate of about 30 to 60%; a specific gravity of about 0.7 to 0.8 (DIN 53479 testing method), tensile strength of about 150 to 170 kg/cm (DIN 53455 testing method), stretch of about 30 to 40% (DIN 53452 testing method), flexural modulus of about 8000 to 9000 kg/cm² (DIN 53452 testing method), impact strength (Charpy) of about 11 to 19 kgf/cm² (DIN 53453 testing method) and hardness (Shore Hardness) of about 20 to 30 N/mm² (DIN 53456 testing method).

Further, another method for producing the adhesive wall finish using compressed plastic panel according to the present invention includes:

A step of using an environmentally friendly plasticizer that does not contain lead and does not contain or use phthalate plasticizer as an ingredient to produce a compressed plastic panel which is about 1 to 3 mm in thickness and is a rigid vinyl chloride foam panel;

A step of selectively using one of PET, PP and PVC, which are environmentally friendly synthetic resins, to obtain environmentally friendly deco sheet laminated with various patterns;

A step of laminating the environmentally friendly deco sheet on one side of the compressed plastic panel using an adhesive member;

A step of obtaining a PE foam sheet having a thickness of about 1 to 3 mm;

A step of applying an adhesive member onto the opposite face of the compressed plastic panel, on one side of which deco sheet is laminated, and laminating with one side of the PE foam sheet;

A step of forming an adhesive face of the PE foam sheet wherein an adhesive member is applied on one side of the PE foam sheet and the adhesive face is finished by attaching release paper thereto, and;

A step of cutting the compressed plastic panel laminated on one side with deco sheet and laminated with PE foam sheet on the other to certain size specifications.

Following the above step of cutting to certain size specifications, a chamfering step wherein corners are sanded down to an incline or pressed so that arranging the adhesive wall finishes side by side causes a V-shaped groove to give a sense of depth may be included additionally.

The adhesive wall finish using compressed plastic panel according to the present invention is characterized in that it is manufactured through the above-described manufacturing method.

As described in the foregoing, the present invention can be easily used as a wall finish firsthand by a consumer; is hard and therefore not easily damaged by sharp objects and is highly moisture resistant while being flexible and less prone to cracking to maintain machinability while having high strength.

Further, it is environmentally friendly due to use of environmentally friendly plasticizer; and by providing a deco sheet whose surface is laminated with synthetic resin, is able to achieve various wall finish colors and patterns.

Additionally, using a PE foam sheet having an adhesive face, it is convenient to install by being attachable over protrusions on a wall surface and being detachable and re-attachable multiple times even if improperly attached by a consumer, can be produced with various thickness and width specifications for greatly improved machinability and product diversity, and is easy to cut and process, facilitating installation.

The scope of the present invention is not limited to the preferable embodiments described in the above, and a PHOSITA may, without departing from the gist of the present invention as claimed in the appended claims, may make various modifications and alterations, which shall be included within the scope of the claims.

### BRIEF DESCRIPTION OF THE DRAWINGS

FIG. 1 is a perspective exploded view showing the adhesive wall finish using compressed plastic panel according to one embodiment of the present invention separated into the environmentally friendly deco sheet, the compressed plastic panel, and the PE foam sheet.

FIG. 2 is a perspective view showing the adhesive wall finish using compressed plastic panel according to one embodiment of the present invention with the environmentally friendly deco sheet, the compressed plastic panel, and the PE foam sheet joined together.

FIG. 3 is a flow chart illustrating the method for manufacturing the adhesive wall finish using compressed plastic panel according to one embodiment of the present invention.

FIG. 4 is a flow chart illustrating the method for manufacturing the adhesive wall finish using compressed plastic panel according to another embodiment of the present invention.

FIG. 5 is an enlarged view showing key parts of the adhesive wall finish using compressed plastic panel according to one embodiment of the present invention when installed on a wall surface.

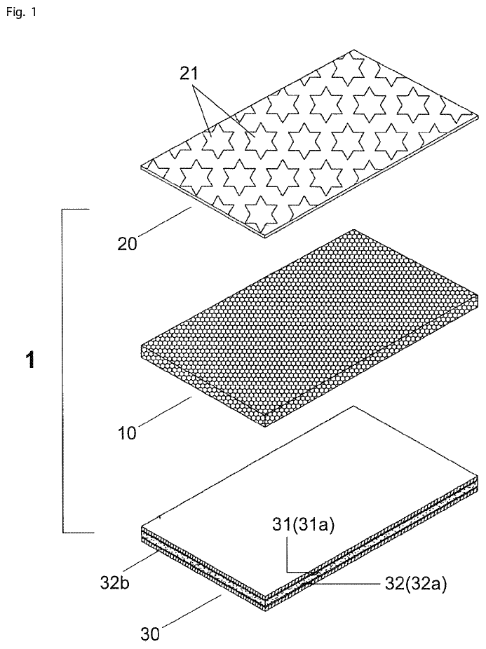

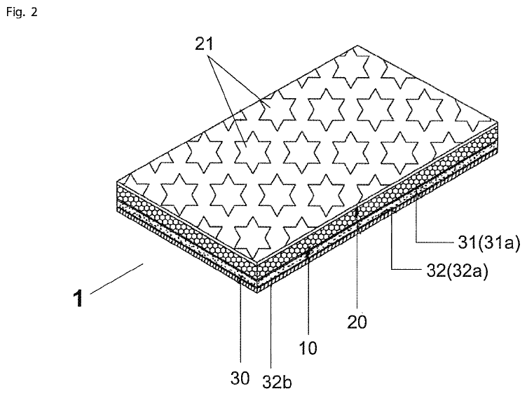

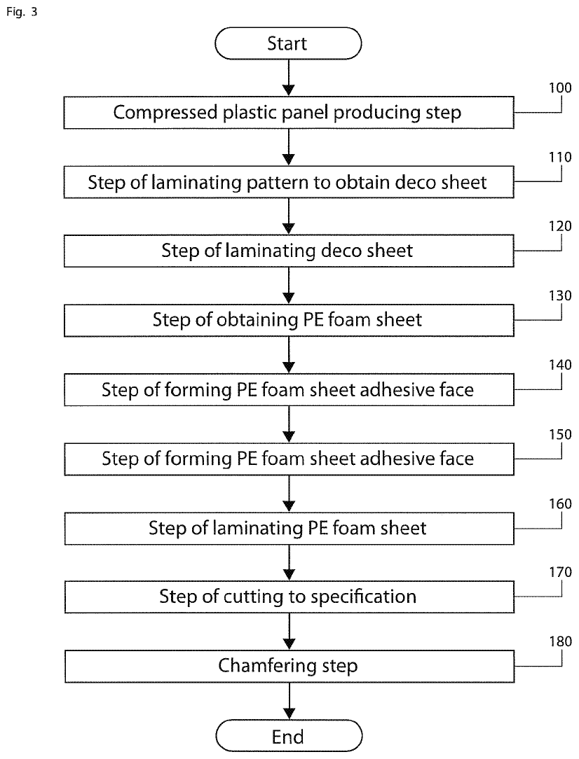

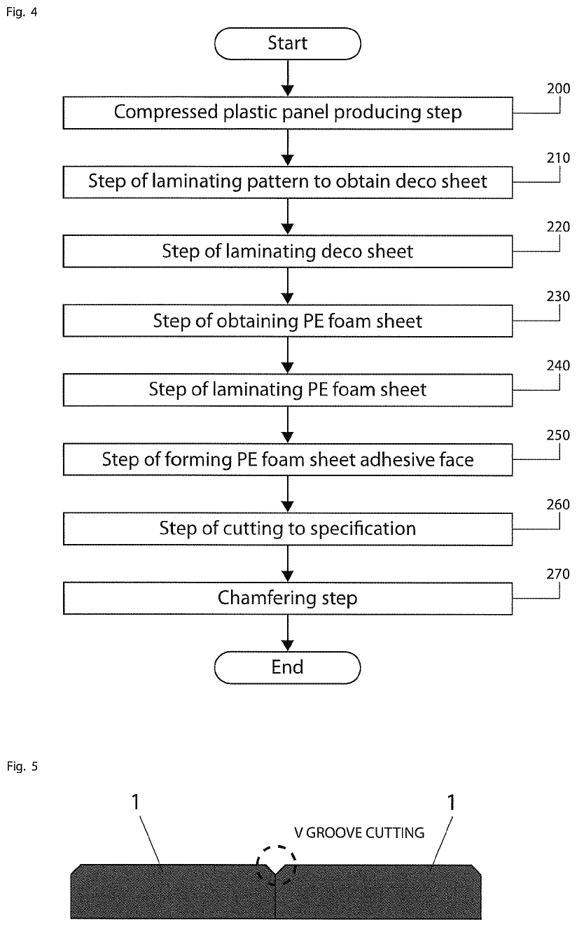

### DETAILED DESCRIPTION OF THE INVENTION

In the following, the present invention is explained in further detail with reference to the attached drawings. Note that, in explaining the present invention, where it is judged that detailed explanation of known relevant functions or components may unnecessary obscure the subject matter of the present invention, such detailed explanation was omitted. Further, the terms used in the following are terms defined in light of their function in the present invention, and may vary depending on users' or operators' intentions or practices. Therefore, the terms should be defined based on the entirety of the specification.

The method for manufacturing the adhesive wall finish using compressed plastic panel of the present invention comprises: a step of using an environmentally friendly plasticizer that does not contain lead and does not contain or use phthalate plasticizer as an ingredient to produce a compressed plastic panel (10) which is about 1 to 3 mm in thickness and is a rigid vinyl chloride foam panel (100); a step of obtaining environmentally friendly deco sheet (20) laminated with various patterns (21); a step of laminating the environmentally friendly deco sheet (20) on one side of the compressed plastic panel (10) using an adhesive member (120); a step of obtaining a PE foam sheet (30) having a thickness of about 1 to 3 mm (130); a step of forming an adhesive face (31) of the PE foam sheet wherein an adhesive member (31a) is applied on one side of the PE foam sheet (30) and the adhesive face (31) is finished by attaching release paper (31b) thereto (140); a step of forming an adhesive face (32) of the PE foam sheet wherein an adhesive member (32a) is applied to the other side of the PE foam sheet (30) and the adhesive face (32) is finished by attaching release paper (32b) thereto (150); a step of laminating the other face of the compressed plastic panel (10) on one side of which the deco sheet (20) is laminated with one side of the PE foam sheet (30) through the adhesive face (31) form which the release paper (31b) has been removed (160); a step of cutting the compressed plastic panel (10) laminated on one side with deco sheet (20) and laminated with PE foam sheet (30) on the other to certain size specifications (170), and; a chamfering step (180) wherein corners are sanded down to an incline or pressed so that arranging the adhesive wall finishes (1) side by side causes a V-shaped groove to give a sense of depth.

In the above, rigid vinyl chloride refers to vinyl chloride resin to which no plasticizer has been added or only a small amount thereof has been added. It refers to soft or plasticized vinyl chloride resin. Rigid vinyl chloride has good mechanical properties except impact resistance, and also has good chemical resistance, and is therefore used in pipes, the linings of chemical tanks or chemical engineering tanks, packings for refrigerator doors, signboards, and ice cream cups, etc.

In the step of producing a compressed plastic panel (10) that is a rigid vinyl chloride foam panel (100), ingredients including thermoplastic resin, which include vinyl chloride resin, foaming agent, foaming aid, heat stabilizer, processing aid, slip agent, impact modifier, plasticizer, dye, and filler are fed into a cylinder of an extruder, then melted from the heat of 150 to 195° C. from a heated barrel and pressure from a screw; are extruded in plate form out of the extruder by passing through any one of a flat manifold die, T-die or coat hanger die, and; the extruded plates pass through a cooling water bath or two or more cooling rollers, to continually produce compressed plastic panels (10) that are rigid vinyl chloride foam panel having: evenly distributed closed cells; a smooth surface; a foaming rate of about 30 to 60%; a specific gravity of about 0.7 to 0.8 (DIN53479 testing method), tensile strength of about 150 to 170 kg/cm (DIN53455), stretch of about 30 to 40% (DIN53452), flexural modulus of about 8000 to 9000 kg/cm² (DIN53452), impact strength (Charpy) of about 11 to 19 kgf/cm² (DIN53453), hardness (Shore Hardness) of about 20 to 30 N/mm² (DIN53456), Vicat softening temperature of about 80° C. (DIN53460), heat distortion temperature (HDT) of about 60° C. (DIN53467), heat conduction of about 0.081 W/mK at 10 mm thickness and about 0.045 to 0.062 W/mK at 20 to 30 mm thickness (DIN52616), absorbance of about <1% (DIN53495), flame resistance that meets the UL94V-0 standard, and sound absorption of about 31 dB at 11 mm and about 34 dB at 19 mm (DIN5210).

Here, the vinyl chloride resin may be a vinyl chloride homopolymer; the foaming agent may be azodicarbonamide; the foaming aid may be para toluene zinc sulfate; the heat stabilizer may be zinc stearate; the slip agent may be high molecular weight polyethylene wax added for synergistic effects with dibasic red stearate; the processing aid may be methyl methacrylate; the impact modifier may be acrylonitrile/butadiene/styrene copolymer; the polymer may be not a phthalate plasticizer but either epoxidized linseed oil (ELO) which has been approved by the FDA for use in food or the environmentally friendly plasticizer DOTP (dioctylterephthalate); the dye may be the rutile type white titanium dioxide dye, and; the filler may be calcium carbonate.

Further, in the step of producing a compressed plastic panel (10) that is a rigid vinyl chloride foam panel (100), flame retardant agent may be added to produce flame retardant (Flame retardant Class 3) products which may be used as a flame retardant wall finish.

Epoxidized linseed oil (W-109, Oxirane oxygen: 4.8%) is an epoxy plasticizer. Epoxy plasticizers having an epoxy group generated by reacting the double bond of linseed oil or ester compounds thereof with peracetic acid or performic acid have superior heat and cold resistance, while functioning as a stabilizer. They are highly compatible with PVC, and are being used widely in applications that require non-toxicity as an indirect food additive.

Products known as environmentally friendly plasticizers are products that do not contain or use as an ingredient phthalate, which is a suspected environmental hormone. Representative environmentally friendly plasticizers available domestically include NEO-T, NEO-T3, NEO-S, PYROCIZER, OLICIZER-10N, OLICIZER-20N, and OLI-3 from Aekyung Petrochemical, GL-100, GL-300, EBN and BET from LG Chemicals, EASTMAN KODA's DOTP, Songwon Industrial Group's P series, as well as WRAPCIZER (Aekyung Petrochemical), CITROCIZER-A(ATBC) (Aekyung Petrochemical), CITROCIZER-W (Aekyung Petrochemical), NEO-A (Aekyung Petrochemical), NEO-E(Aekyung Petrochemical), LGflex EBN-W(N) (LG Chemicals), AMG (Aekyung Petrochemical, Ilshin Wells, Riken (Japan)), among others.

Among these, the greatest advantage of DOTP (dioctyl terephthalate), whose use as an environmentally friendly plasticizer is increasing, is its environmental friendliness. In various toxicity testing data announced until now, DOTP has been found to have no toxic effect on the human body, including carcinogenicity. Also, its boiling point, freezing point and density, etc. are similar to those of DOP (dioctyl phthalate; synonymous with polychloride vinyl plasticizer not only in Japan and the US, but globally; causes substances suspected to be environmental hormones), and therefore it exhibits advantages in volatility and electrical insulation.

The compressed plastic panels (10) of about 1 to 3 mm in thickness produced through the step (100) of producing a compressed plastic panel (10) have a specific gravity of about 0.7 to 0.8 (DIN53479 testing method), about 150 to 170 kg/cm (DIN53455) tensile strength, about 30 to 40% (DIN53452) stretch, flexural modulus of about 8000 to 9000 kg/cm² (DIN53452), impact strength (Charpy) of about 11 to 19 kgf/cm² (DIN53453) and hardness (Shore Hardness) of about 20 to 30 N/mm² (DIN53456). Compared to conventional PVC tile products whose flexibility was high but had low hardness and were prone to thermal expansion and contraction, they are highly moisture resistance and suitably flexible to allow for processability while maintaining hardness.

The present invention is manufactured through: a step of producing a compressed plastic panel (100); a step of obtaining environmentally friendly deco sheet (20) laminated with various patterns (21), and; a step of laminating the environmentally friendly deco sheet (20) on one side of the compressed plastic panel (10) using an adhesive member (120).

This is followed by a step of obtaining a PE foam sheet (30) having a thickness of about 1 to 3 mm(130); a step of forming an adhesive face (31) of the PE foam sheet wherein an adhesive member (31a) is applied on one side of the PE foam sheet(30) and the adhesive face (31) is finished by attaching release paper (31b) thereto (140), and; a step of forming an adhesive face (32) of the PE foam sheet wherein an adhesive member (32a) is applied to the other side of the PE foam sheet (30) and the adhesive face (32) is finished by attaching release paper (32b) thereto (150).

Next are a step of laminating the other face of the compressed plastic panel (10) on one side of which the deco sheet (20) is laminated with one side of the PE foam sheet (30) through the adhesive face (31) form which the release paper (31b) has been removed (160); a step of cutting the compressed plastic panel (10) laminated on one side with deco sheet (20) and laminated with PE foam sheet (30) on the other to certain size specifications (170), and; a chamfering step (180) (270) wherein corners are sanded down to an incline or pressed so that arranging the adhesive wall finishes (1) side by side causes a V-shaped groove to give a sense of depth. This yields adhesive wall finishes of various sizes having deco sheet (20) laminated with patterning (21) on one side.

By forming, as described in the above, a deco sheet (20) laminated with patterning (21) on one side of a compressed plastic panel (10), an adhesive wall finish (1) where bending of the compressed plastic panel (10) in one direction can be prevented beforehand is obtained.

The adhesive wall finish (1) may be installed by a user by removing the release paper (32a) of the PE foam sheet (30) beneath the compressed plastic panel (10) to expose the adhesive face (32), then attaching the wall finishes on the desired indoor wall surface of a building, firmly securing the adhesive wall finishes (1).

Here, the adhesive face (32) of the adhesive wall finish (1) allows easy detaching and re-attaching if improperly attached by the consumer.

Further, by virtue of the PE foam sheet (30), the adhesive wall finish can be easily attached and fixed to wall surfaces with bumps.

Another method for manufacturing the adhesive wall finish using compressed plastic panel of the present invention comprises: a step of producing a compressed plastic panel (10) which is about 1 to 3 mm in thickness and is a rigid vinyl chloride foam panel (200); a step of obtaining environmentally friendly deco sheet (20) laminated with various patterns (21) (210); a step of laminating the environmentally friendly deco sheet (20) on one side of the compressed plastic panel (10) using an adhesive member (220); a step of obtaining a PE foam sheet (30) having a thickness of about 1 to 3 mm (230); a step of applying an adhesive member (31a) to the opposite side of the compressed plastic panel (10) on one side of which deco sheet (20) is laminated, then laminating one side of the PE foam sheet (30) thereonto (240); a step of forming an adhesive face (32) by applying an adhesive member (32a) to the other face of the PE foam sheet (30) laminated onto the other face of the compressed plastic panel (10) and finishing the adhesive face (32) by attaching release paper (32b) (250); a step of cutting the compressed plastic panel (10) laminated on one side with deco sheet (20) and laminated with PE foam sheet (30) on the other to certain size specifications (260), and; a chamfering step (180) (270) wherein corners are sanded down to an incline or pressed so that arranging the adhesive wall finishes (1) side by side causes a V-shaped groove to give a sense of depth.

The adhesive wall finish (1) of the present invention described above, by using environmentally friendly plasticizers that do not contain phthalates suspected to be environmental hormones or do not use them as ingredients, being an environmentally friendly product, does not cause any problems to the human body with respect to environmental hormones even when used as a finish for building wall surfaces. Further, it has strong moisture resistance, flexibility and sound insulation, while maintaining processability and high strength to allow for easy firsthand cutting and processing by consumers and make possible great savings in the overall cost of production.

The physical properties of the adhesive wall finish (1) of the present invention and conventional PVC tile are compared in Table 1 below:

| | | | | Conventional | Adhesive tile of the | | | |
|---|---|---|---|---|---|---|---|---|
| | | | | PVC | invention | | | |
| Test Item | | Unit | SPEC | tile | #1 | #2 | #3 | Average |
| Residual indentation | | % | ≤8 | 2.8~5.7 | 32.44 | 30.56 | 29.28 | 30.76 |
| Indentation | 20□ | mm | ≥0.25 | 0.33~0.36 | 0.78 | 0.80 | 0.76 | 0.78 |
| | 45□ | mm | ≤1.20 | 0.45~0.65 | 0.92 | 0.92 | 0.92 | 0.92 |
| Heating loss | | % | ≤0.50 | 0.10~0.19 | 1.54 | 1.17 | 1.17 | 1.29 |
| Length change | MD | % | ≤0.25 | 0.04~0.07 | | | | −2.62 |
| under heat | CD | % | ≤0.25 | 0.04~0.07 | | | | 0.86 |

That is, in the adhesive wall finish (1) of the present invention, use of a rigid vinyl chloride foam board ensures strength, flexibility and processability of the product. Whereas the material is rigid, being a foam, it can be easy cut as needed by a consumer using a box cutter or scissors. Also, while flexible, the material is not soft, and is able to maintain a flat surface.

Further, the adhesive wall finish (1) of the present invention is a sticker type product which can be installed quickly and conveniently firsthand by a consumer at a low cost. By using PE foam on the rear adhesive face, the wall finish adheres well even to uneven wall surfaces. Also, as the finished product is in the shape of a panel or tile, it is possible to give a 3D effect.

Additionally, the adhesive wall finish (1) of the present invention, being made of synthetic resin material, has high moisture resistance, and, being a foam product, has a certain noise proofing effect. By laminating the surface with synthetic resin, it is possible to realize various colors and patterns.

Explanation of referenced features shown in the drawings:

| | |
|---|---|
| 1: Adhesive wall finish | |
| 10: Compressed plastic panel | |
| 20: Deco sheet | 21: Patterning |
| 30: PE foam sheet | 31: Adhesive face |
| 31a: Adhesive member | 31b: Release paper |
| 32: Adhesive face | 32a: Adhesive member |
| 32b: Release paper | |
| 100: Compressed plastic panel producing step | |
| 110: Step of laminating pattern to obtain deco | |
| sheet | |
| 120: Step of laminating deco sheet | |
| 130: Step of obtaining PE foam sheet | |
| 140: Step of forming PE foam sheet adhesive face | |
| 150: Step of forming PE foam sheet adhesive face | |
| 160: Step of laminating PE foam sheet | |
| 170: Step of cutting to specification | |
| 180: Chamfering step | |
| 200: Compressed plastic panel producing step | |
| 210: Step of laminating pattern to obtain deco | |
| sheet | |
| 220: Step of laminating deco sheet | |
| 230: Step of obtaining PE foam sheet | |
| 240: Step of laminating PE foam sheet | |
| 250: Step of forming PE foam sheet adhesive face | |
| 260: Step of cutting to specification | |
| 270: Chamfering step. | |

What is claimed is:

1. A method for manufacturing an adhesive wall finish using compressed plastic panel, comprising:
a step of using an environmentally friendly plasticizer that does not contain lead and does not contain or use phthalate plasticizer as an ingredient to produce a compressed plastic panel having a thickness of about 1 to 3 mm and comprising a rigid vinyl chloride foam panel;
a step of obtaining an environmentally friendly deco sheet laminated with various patterns and comprising at least one environmentally friendly synthetic resin, selected from the group consisting of PET, PP and PVC;
a step of laminating the environmentally friendly deco sheet on one side of the compressed plastic panel using an adhesive member;
a step of obtaining a PE foam sheet having a thickness of about 1 to 3 mm;
a step of forming a first adhesive face of the PE foam sheet, wherein an adhesive member is applied on one side of the PE foam sheet and the first adhesive face of the PE foam sheet is finished by attaching a release paper thereto;
a step of forming a second adhesive face of the PE foam sheet, wherein an adhesive member is applied to an opposite side of the PE foam sheet and the second adhesive face is finished by attaching a release paper thereto;
a step of laminating an opposite side of the compressed plastic panel with one side of the PE foam sheet through the first adhesive face, from which the release paper has been removed; and
a step of cutting the compressed plastic panel laminated on one side with deco sheet and laminated with PE foam sheet on the other to certain size specifications.

2. The method according to claim 1, wherein the step of producing the compressed plastic panel comprises:
feeding a mixture of ingredients into a hopper of an extruder;
passing the mixture through a barrel heated to about 150 to 195° C. of any one of a manifold-type flat die, T-die and coat hanger type die; and
passing the mixture through a cooling water bath or at least two cooling rollers to continually produce vinyl chloride foam panels having:
evenly distributed closed cells;
a smooth surface;
a foaming rate of about 30 to 60%;
a specific gravity of about 0.7 to 0.8;
a tensile strength of about 150 to 170 kg/cm;
a stretch of about 30 to 40%;
a flexural modulus of about 8000 to 9000 kg/cm²;
an impact strength of about 11 to 19 kgf/cm²; and
a hardness of about 20 to 30 N/mm².

3. The method according to claim 1, further comprising, after the step of cutting to size specifications, a chamfering step wherein corners of the compressed plastic panel are sanded down to an incline or pressed such that arranging adhesive wall finishes side by side causes a V-shaped groove to give a sense of depth.

4. An adhesive wall finish using a compressed plastic panel manufactured according to the manufacturing method of claim 1.

5. A method for manufacturing an adhesive wall finish using compressed plastic panel, comprising:
a step of using an environmentally friendly plasticizer that does not contain lead and does not contain or use phthalate plasticizer as an ingredient to produce a compressed plastic panel having a thickness of about 1 to 3 mm and comprising a rigid vinyl chloride foam panel;
a step of obtaining an environmentally friendly deco sheet laminated with various patterns and comprising at least one environmentally friendly synthetic resin, selected from the group consisting of PET, PP and PVC;
a step of laminating the environmentally friendly deco sheet on a first side of the compressed plastic panel using an adhesive member;
a step of obtaining a PE foam sheet having a thickness of about 1 to 3 mm and having a first side and a second side;
a step of applying an adhesive member to a second side of the compressed plastic panel and laminating the first side of the PE foam sheet thereonto;
a step of forming an adhesive face by applying an adhesive member to the second side of the PE foam sheet and finishing the adhesive face by attaching a release paper thereto; and
a step of cutting the compressed plastic panel laminated on the first side with the deco sheet laminated on the second side with the PE foam sheet to certain size specifications.

6. A method for manufacturing an adhesive wall finish using compressed plastic panel, comprising:
forming a compressed plastic panel having a first side and a second side;
laminating a deco sheet onto the first side of the compressed plastic panel using an adhesive member, wherein the deco sheet is laminated with at least one decorative pattern;
obtaining a PE foam sheet having a first side and a second side;
forming a first adhesive face on the PE foam sheet by applying an adhesive member to the first side of the PE foam sheet and attaching a release paper thereto;
forming a second adhesive face on the PE foam sheet by applying an adhesive member to the second side of the PE foam sheet and attaching a release paper thereto;
laminating the second side of the compressed plastic panel with one side of the PE foam sheet through the first adhesive face, from which the release paper has been removed; and
cutting the compressed plastic panel to certain size specifications.

7. The method according to claim 6, wherein the compressed plastic panel has a thickness of about 1 to 3 mm.

8. The method according to claim 6, wherein the compressed plastic panel comprises an environmentally friendly plasticizer that does not contain lead or phthalate plasticizer as an ingredient.

9. The method according to claim 6, wherein the compressed plastic panel comprises a rigid vinyl chloride foam panel.

10. The method according to claim 6, wherein the deco sheet comprises at least one environmentally friendly synthetic resin selected from the group consisting of PET, PP and PVC.

11. The method according to claim 6, wherein the PE foam sheet has a thickness of about 1 to 3 mm.

12. The method according to claim 6, wherein the step of forming the compressed plastic panel comprises:
feeding a mixture of ingredients into an extruder;
passing the mixture through a barrel heated to about 150 to 195° C.; and
passing the mixture through a cooling chamber.

13. An adhesive wall finish, comprising:
a compressed plastic panel having a thickness of about 1 to 3 mm, a first side and a second side, wherein the compressed plastic panel comprises a rigid vinyl chloride foam panel;
a deco sheet laminated with at least one decorative pattern and comprising at least one synthetic resin, selected from the group consisting of PET, PP and PVC, wherein the deco sheet is laminated onto the first side of the compressed plastic panel using an adhesive member; and
a PE foam sheet having a thickness of about 1 to 3 mm, a first side and a second side, wherein the first side of the PE foam sheet is laminated onto the second side of the compressed plastic panel using an adhesive member;
wherein the second side of the PE foam sheet has an adhesive face comprising an adhesive member applied to the second side of the PE foam sheet and a removable release paper applied to the adhesive member.

14. The adhesive wall finish according to claim 13, wherein the compressed plastic panel has a foaming rate of about 30 to 60%.

15. The adhesive wall finish according to claim 13, wherein the compressed plastic panel has a specific gravity of about 0.7 to 0.8.

16. The adhesive wall finish according to claim 13, wherein the compressed plastic panel has a tensile strength of about 150 to 170 kg/cm.

17. The adhesive wall finish according to claim 13, wherein the compressed plastic panel has a stretch of about 30 to 40%.

18. The adhesive wall finish according to claim 13, wherein the compressed plastic panel has a flexural modulus of about 8000 to 9000 kg/cm².

19. The adhesive wall finish according to claim 13, wherein the compressed plastic panel has an impact strength of about 11 to 19 kgf/cm².

20. The adhesive wall finish according to claim 13, wherein the compressed plastic panel has a hardness of about 20 to 30 N/mm².
